(19) United States
(12) Patent Application Publication
(10) Pub. No.: US 2009/0218924 A1
(43) Pub. Date: Sep. 3, 2009

(54) LIGHT SOURCE FOR ULTRAVIOLET RAY IRRADIATION

(75) Inventor: Nozomu Tajika, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/396,707

(22) Filed: Mar. 3, 2009

(30) Foreign Application Priority Data
Mar. 3, 2008 (JP) 2008-51893

(51) Int. Cl. H01J 7/26

(52) U.S. Cl. 313/36

(57) ABSTRACT

A light source for ultraviolet ray irradiation, comprises a rod-shaped discharge lamp having an arc tube, wherein a chip formed in the arc tube is dented so as not to project from an outer surface of the arc tube, a cooling jacket having an inner pipe and an outside pipe, between which cooling fluid flows, wherein the discharge lamp is arranged so that a portion where the chip of the arc tube is formed is located in a lower portion in a gravity direction.

### CROSS-REFERENCES TO RELATED APPLICATION

This application claims priority from Japanese Patent Application Serial No. 2008-051893 filed Mar. 3, 2008, the content of which is incorporated herein by reference in its entirety.

### TECHNICAL FIELD

Described herein is a light source for an ultraviolet ray irradiation, which has a cooling jacket for cooling a discharge lamp by passing cooling fluid therein.

### BACKGROUND

In various fields, a lamp which emits light including ultraviolet rays is widely used to harden, dry, melt, soften, reform etc. a protective coat, an adhesive agent, a paint, ink, a resist, resin, a photo-alignment film, etc. Specifically, such a lamp which emits ultraviolet rays used for these uses, is a long arc discharge lamp (having a rod-shape), such as a high-pressure mercury lamp and a metal halide lamp, with which a high output is obtained. A pair of electrodes is arranged inside a rod-shaped arc tube (a seal body) of the lamp, and for example, mercury, or other metal, etc. is enclosed in the arc tube if needed.

It is required that a work piece be irradiated with light having a high output in the discharge lamp. Therefore, in order to raise electric power to be inputted into the lamp, a discharge lamp is used as a light source for an ultraviolet ray irradiation, wherein the discharge lamp is installed inside a double pipe type cooling jacket comprising an inner pipe and an outside pipe, which are approximately cylindrical and have ultraviolet-rays permeability (for example, refer to Japanese Laid Open Patent Nos. 61-158453 and 56-155765). If this light source for an ultraviolet ray irradiation is used without cooling by the cooling jacket, the lamp input has to be made small, since the temperature of an arc tube reaches 1000 degrees Celsius or more, so that the arc tube is overheated thereby causing devitrification. However, by using such a cooling jacket, the temperature of the arc tube can be made lower than that in case where the lamp is lighted without cooling or by only air cooling, and it is possible to impress large electric power to the lamp so that it is possible to realize a high ultraviolet-rays output.

FIG. 3A is a schematic perspective view of the structure of a light source for an ultraviolet ray irradiation having a double pipe type cooling jacket of the prior art. FIG. 3B is a cross sectional view of the light source for an ultraviolet ray irradiation, taken along a line 3B-3B shown in FIG. 3A. In addition, since the cooling jacket is a water cooling type jacket, it is merely referred to as a water cooling jacket below. As shown in these figures, the double pipe type water cooling jacket 101 is attached to a rod-shaped lamp 100. The water cooling jacket 101 comprises a cylindrical inner pipe 102 and an outside pipe 103. A cooling medium, for example, cooling water, flows between the inner pipe 102 and the outside pipe 103 from a coolant inlet 108, and is discharged from a coolant outlet 109. As described above, a cylindrical high-pressure mercury lamp or a cylindrical metal halide lamp, which emits ultraviolet rays efficiently, is used as the lamp 100, wherein a pair of electric discharge electrodes 105 and 106 is provided in both sides of the lamp, and electric power is supplied to the lamp from the electrodes 105 and 106 through lead wires 107 for supplying electric power.

The lamp 100 is inserted into the inner pipe 102, and an air layer 111 whose thickness is, for example, approximately 0.5 to 1 mm is provided between the lamp 100 and the inner pipe 102. When the lamp is lighted, the cooling water flows in the water cooled layer 104 between the inner pipe 102 and the outside pipe 103, and the work piece (not shown) is irradiated with light emitted from the lamp 100 through this water-cooled layer 104.

In such a light source for an ultraviolet ray irradiation, the water cooling jacket 101 mainly has two functions. One of the functions is to cool the lamp 100 while the lamp is lighted, so as to maintain a suitable temperature thereof. Where the temperature of the arc tube of the lamp 100 at time when the lamp is lighted, is 450-900 degrees Celsius, the temperature thereof is in general deemed suitable to evaporate the mercury or metal in the arc tube. If the temperature thereof goes down to 450 degrees Celsius or lower, the metal such as the mercury enclosed in the lamp 100, stops evaporating so that light vanishes. Moreover, if the temperature thereof reaches 900 degrees Celsius or higher, the quartz which forms the arc tube devitrifies. The heat of the lamp 100 is conducted to the water cooling jacket 101 through the air layer 111 between the lamp 100 and the inner pipe 102, and is cooled with the cooling water which flows between the inner pipe 102 and the outside pipe 103 of the water cooling jacket 101.

Thus, although the cooling water which flows inside the water cooling jacket 101 prevents overheating of the lamp 100, since the arc tube is indirectly cooled through the air layer 111, the temperature of the arc tube is not lowered to a temperature at which the metal inside the lamp stops evaporating. The cooling water which flows through the water cooling jacket 101 works so that the arc tube of the lamp 100 may be maintained at a suitable temperature.

The other function of the water cooling jacket is to make small the influence of the heat from the lamp 100 to the work piece. That is, first, the water-cooled layer 104 absorbs the radiant heat from the arc tube whose temperature is 450-900 degrees Celsius. Moreover, components of light from visible light to infrared rays, which are contained in the light emitted from the lamp 100 and which are not necessary for an ultraviolet treatment, are absorbed therein, so that the heating of the work piece can be suppressed to a low degree. Therefore, although it is possible to reduce the influences of the heating of the work piece as the interval between the inner pipe 102 and the outside pipe 103 is larger, i.e., the thickness of the water-cooled layer 104, is large, the ultraviolet ray transmissivity which is required for the processing decreases if the thickness is too large. Therefore, these factors are taken into consideration so as to suitably set up the configuration.

As described above, a cylindrical high-pressure mercury lamp, or a cylindrical metal halide lamp, etc. which has a large output and which is capable of shortening the processing time, is used as the lamp 100. However, in the arc tube (sealing body) of such a lamp, a remaining portion of a gas exhaust pipe, called a chip, (specifically, a pipe for adjusting the inner pressure to a predetermined pressure, while introducing the necessary gas in the arc tube) which is used in a manufacturing process of the lamp, usually exists, projecting from the outer surface of the arc tube of the lamp, by approximately 1 mm.

However, if such a chip projects from the outer surface of the arc tube, when the lamp is installed in the water cooling jacket, the interval between the lamp and the inner pipe of the water cooling jacket is restricted. Namely, since the lamp cannot be brought close to the inner wall of the water cooling jacket, at a distance shorter than the height of the chip projected from the arc tube, the lamp to be turned on with a high input cannot be fully cooled down. Therefore, in a lamp contained in a cooling jacket disclosed in Japanese Utility Model Patent Publication No. 60-11270, a chip is pushed into an arc tube so as not to project from the outer surface of the arc tube.

FIG. 4 is an enlarged cross sectional view of part of a cylindrical discharge lamp contained in a cooling jacket, taken along a longitudinal direction of the cylindrical discharge lamp, wherein a chip is dented so as not to project from the outer surface of the arc tube.

The procedure of pushing the chip into the arc tube will be described below, referring to FIG. 4. After necessary gas is introduced in the arc tube (sealing body) 110 of the lamp and then discharged therefrom for adjustment of the internal pressure thereof, the chip T is sealed and cut therefrom. At this time, the chip T is projected from the outer surface of the arc tube. After that, a circumference section B of the chip T is heated so as to be softened, and then the chip T is pushed into the inner side of the arc tube 110, so as not to project from the outer surface of the arc tube. Therefore, as shown in FIG. 4, the circumference portion B around the chip (portions surrounded by a dotted line) is dented in the arc tube 110 by only the height of a portion of the chip T which has been pushed in the arc tube, so as to be located inside the outer surface of the arc tube 110 by approximately 1 mm.

When a lamp in which such a chip has been pushed in the arc tube so as not to project from the outer surface of the arc tube is inserted in a water cooling jacket, and is turned on, it turned out that devitrification arises in a portion where the chip is formed, depending on the directions (position) of the portion in which the chip of the arc tube is formed, with respect to the center of the lamp, in a cross sectional view of the lamp, taken along a plane perpendicular to the axis of the arc tube of the lamp. In the conventional light source for an ultraviolet ray irradiation in which a discharge lamp is arranged in a water cooling jacket, it was not known about the relation between the direction (position) of a portion in which the chip of the arc tube is formed, and devitrification of the portion.

In view of the above problem, examination is made about the relation between the direction (position) of a portion in which a chip of an arc tube is formed and devitrification of the portion, in a light source for an ultraviolet ray irradiation, in which a cylindrical discharge lamp whose chip is dented so as not to project from the outer surface of the arc tube, is arranged in a water cooling jacket, and further a light source for an ultraviolet ray irradiation is offered, wherein devitrification in the portion in which the chip of the arc tube is formed is prevented.

### SUMMARY

In order to solve the above problems, a discharge lamp is provided in a cooling jacket so that a portion where a chip is formed in an arc tube thereof, is located in a lower portion in the gravity direction. It is desirable that, where a vertical direction from the center of the lamp is defined as zero (0) degree, the “lower portion in the gravity direction” may be defined as an area where a portion in which the chip of an arc tube is formed is located in a range of ±45 degrees or lower from the vertical direction.

As described as the prior art, when the chip is pushed in the arc tube so as not to project from the outer surface of the arc tube, the circumference section surrounding the chip is dented, so as to be located inside the outer surface of the arc tube by approximately 1 mm. Therefore, when such a lamp is arranged in the cooling jacket, the circumference section (the portion B shown in FIG. 4) around the chip of the lamp is away from the inner pipe of the cooling jacket, farther than the outer surface of the arc tube. Therefore, the temperature of the circumference section around the chip becomes higher than the temperature of the outer surface of the arc tube when the lamp is lighted.

As a keen examination by the inventor, it turned out that an upper portion of the arc tube tends to be high in temperature, and the temperature of the arc tube goes up suddenly when the interval between the cooling jacket and the arc tube is broaden even a little, since an arc which is developed between electric discharge electrodes is especially brought in an upper direction opposite to the gravity direction by convection in the arc tube when the lamp is lighted. For example, the temperature of the upper portion of the arc tube rises by approximately 300 degrees Celsius when the outer surface of the arc tube becomes far from the cooling jacket by only 1 mm.

As described above, when the lamp is lighted, the suitable temperature of the arc tube is 450-900 degrees Celsius. Therefore, the interval between the arc tube of the lamp and the inner pipe of the water cooling jacket is set so that the temperature thereof may fall within that temperature range. In this case, when a portion where the chip of the arc tube is formed in the lamp is arranged in an upper portion in a direction opposite to the gravity direction, as mentioned above, since the circumference section surrounding the chip is dented by approximately 1 mm from the outer surface of the arc tube, even if the temperature of the arc tube is, for example, approximately 700 degrees Celsius, the temperature of the portion which is dented inside the arc tube in the circumference section of the chip reaches approximately 1000 degrees Celsius so that it exceeds the suitable temperature range, thereby causing devitrification.

On the other hand, on the contrary, a lower part of the arc tube becomes far from the arc. Therefore, the temperature of the lower part of the arc tube becomes lower than that in an upper part of the arc tube. Even if the arc tube becomes far from the inner pipe of a cooling jacket by 1 mm, the temperature thereof rises only by approximately 50 degrees. Therefore, in case where the lamp is arranged in a cooling jacket so that the portion where the chip of the arc tube is formed is located in a portion in the gravity downward direction, when the temperature of the arc tube is 700 degrees Celsius, even if the portion which is dented in the arc tube in the circumference section surrounding the chip becomes high in temperature, it is 750 degrees Celsius, so that the temperature of the arc tube of the lamp is maintained in the suitable temperature range.

The present rod-shaped cylindrical discharge lamp in which a chip is dented so as not to project from the outer surface of the arc tube, is arranged in the cooling jacket so that a portion where the chip of the arc tube is formed may be located in a lower portion in the gravity downward direction, whereby devitrification of the lamp can be prevented.

### BRIEF DESCRIPTION OF DRAWINGS

Other features and advantages of the present light source for an ultraviolet ray radiation will be apparent from the ensuing description, taken in conjunction with the accompanying drawings, in which:

FIG. 1 shows the relation between the position of a portion where a chip of an arc tube is formed and the temperature of a circumference section surrounding the chip when the lamp is lighted;

FIG. 2 is a cross sectional view of a light source for an ultraviolet ray irradiation according to the present embodiment;

FIGS. 3A and 3B are views showing the configuration of a light source for an ultraviolet ray irradiation having a conventional cooling jacket; and

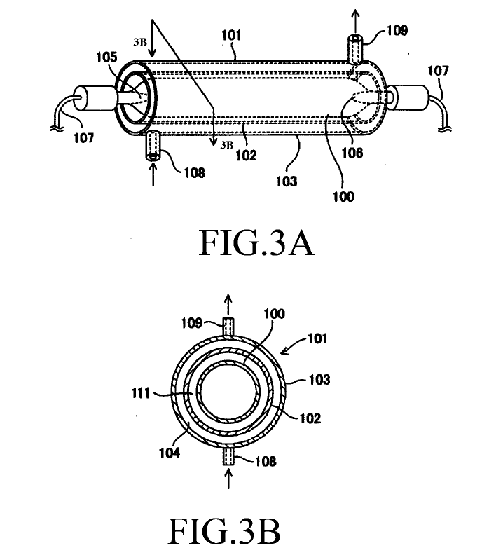

FIG. 4 is an enlarged cross sectional view of a portion where a chip of the discharge lamp is dented.

### DETAILED DESCRIPTION

A description will now be given, referring to embodiments of the present light source for an ultraviolet ray radiation. While the claims are not limited to such embodiments, an appreciation of various aspects of the present lamp emitting device is best gained through a discussion of various examples thereof.

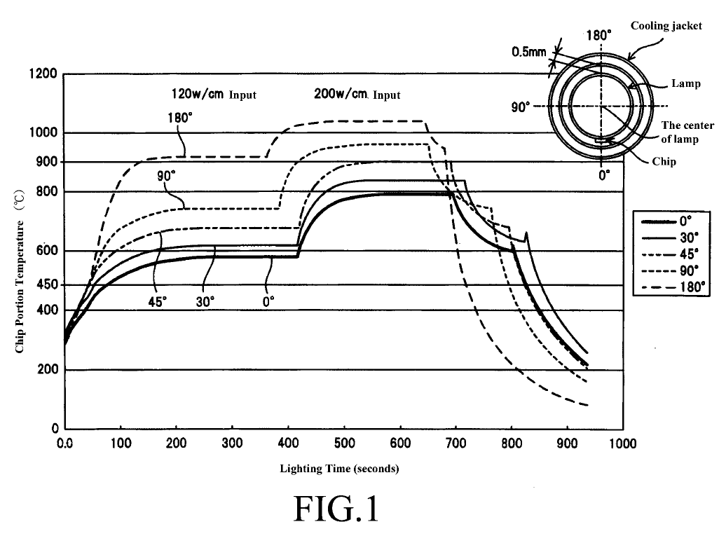

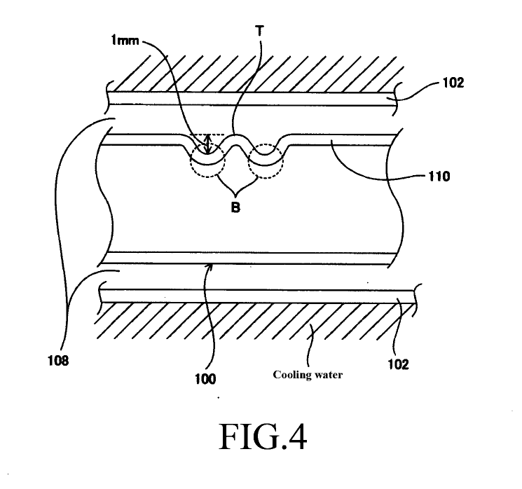

FIG. 1 shows the relation of the position of a portion where a chip of an arc tube is formed in a cylindrical discharge lamp which is arranged in a cooling jacket, and the temperature of a circumference section surrounding the chip when the lamp is lighted (a section B shown in FIG. 4). The horizontal axis of this figure is lighting time (second) of the lamp, and the vertical axis is temperature (degree C.). When the chip is located on a hypothetical line (direction) which is vertically drawn from the center of the lamp, the angle position of the chip is represented as zero (0) degree. The temperature of the circumference section surrounding the chip was respectively measured at five positions, that is, 0, 30, 45, 90, and 180 degrees, while electric power of 120 W/cm (electric power in a standby state) and 200 W/cm (rated power) was inputted in the lamp, respectively. In addition, the interval between an outer surface of the arc tube of the lamp (a portion other than the portion where the chip was formed) and the inner wall of the cooling jacket was 0.5 mm.

When the lamp was arranged so that the portion where the chip was formed, was located at 180 degrees, i.e., the position where the chip of the arc tube was formed, was located in an upper portion in a direction opposite to the gravity upward direction, the temperature of the circumference section surrounding the chip exceeded 900 degrees Celsius which was an upper limit of the suitable temperature range, as shown in this figure. Moreover, when the lamp was arranged so that the portion where the chip of the arc tube was formed, was located at 90 degrees, i.e., the chip was directed in a transverse direction, in the case where the input was 120 W/cm, the temperature fell within the suitable temperature range, but in the case where the input was 200 W/cm, the temperature exceeded 900 degrees Celsius.

On the other hand, when the position where the chip was formed was located at 45 degrees, that is, when the lamp was arranged so that the portion where the chip of an arc tube was formed was located in a lower portion in the gravity downward direction, not only in the case where the input was 120 W/cm, but also in the case where the input was 200 W/cm, the temperature of the circumference section surrounding the chip did not exceed 900 degrees Celsius, so as to fall within the suitable temperature range of 450-900 degrees Celsius. Similarly, when the portion where the chip of the arc tube is formed is located in a lower portion in the gravity direction, for example, in the case of 0 degree or 30 degrees, in either the case where the input was 120 W/cm or the case where the input was 200 W/cm, the temperature of the circumference section surrounding the chip fell within the suitable temperature range of 450-900 degrees Celsius

Therefore, it is possible to prevent devitrification of the arc tube by arranging the lamp in the cooling jacket so that the portion where the chip of an arc tube is formed is located in a lower portion in the gravity direction. Moreover, it is desirable to arrange the lamp so that a portion where the chip is formed may be located in a range of ±45 degrees, where the angle position is represented as zero (0) degree when the chip is located in a vertical direction (line) from the center of the lamp.

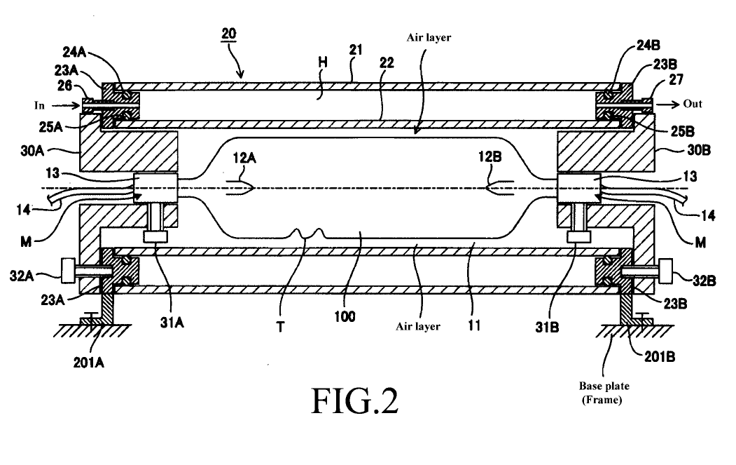

FIG. 2 is a cross sectional view of a light source for an ultraviolet ray irradiation according to the present embodiment, taken along a longitudinal direction of a rod-shaped lamp thereof, wherein a rod-shaped lamp in which a chip formed in an arc tube is dented so as not to project from the outer surface of the arc tube, is arranged in a cooling jacket, so that the portion where the chip of the arc tube is formed, may be located in a lower portion in the gravity direction. A cooling (water cooling) jacket 20 comprises an outside pipe 21 and an inner pipe 22, both of which are made of quartz glass which transmits ultraviolet rays, a pair of jacket holders 23A and 23B respectively arranged to the both ends of the cooling jacket 20, and O-rings 24A, 25A, 24B, and 25B for maintaining cooling fluid H (for example, cooling water) liquid-tightly in the jacket holder.

The jacket holders 23A and 23B which are made of aluminum, are in contact with end surfaces of the outside pipe 21 and the inner pipe 22 made of quartz glass, so as to define the positions thereof in axial directions, and in addition, the interval between the outside pipe 21 and the inner pipe 22, between which the cooling fluid H flows, is also defined thereby. In addition, a feed port 26 and an exhaust port 27 of the cooling fluid H are respectively formed in the jacket holders 23A and 23B. Moreover, leg members 201A and 201B are attached to the jacket holders 23A and 23B, so that the water cooling jacket 20 is fixed to a base plate or a frame of the ultraviolet ray irradiation apparatus by the leg members 201A and 201B.

The rod-shaped discharge lamp 100 (hereinafter referred to as a lamp) is a high output and high pressure mercury lamp or a high output metal halide lamp. For example, a pair of electrodes 12A and 12B made of tungsten is arranged, facing each other in the rod-shaped arc tube 11 (also referred to as a sealing body) made of quartz glass, wherein light-emitting material as argon gas and mercury as electric discharge gas is enclosed in the arc tube. In addition, in the case of the metal halide lamp, an appropriate amount of the metallic compound other than the mercury may be enclosed. The full length of the arc tube 11 is 320 mm and the length of the light emission section (namely, distance between the electrodes) is 200 mm. In addition, in the discharge lamp 100 according to the present embodiment, the diameter of the light emission section of the arc tube 11 is throughout its length, except for the portion of the chip T, so that the arc tube may be in the shape of a straight pipe.

Bases 13 made from ceramics are provided at both ends of the lamp 100. The lead wires 14 which supply electric power to the electrodes 12A and 12B are connected to the respective bases 13. The bases 13 of the lamp 100 are respectively inserted in lamp holders 30A and 30B, and are respectively fixed by setscrews 31A and 31B. Lamp holders 30A and 30B are fixed to the jacket holders 23A and 23B so that the interval of the lamp 100 and the inner pipe 22 may be a predetermined width. Thus, the lamp 100 is fixed in the cooling jacket 20.

Described below is the procedure of arranging the lamp 100 in the cooling jacket 20 wherein the portion of the arc tube 11 where the chip T is formed is located in a lower portion in the gravity direction (in the range of ±45 degrees where a vertical direction from the center of the lamp is defined as zero (0)). The bases 13 are attached to both ends of the lamp 100 in the longitudinal direction with an adhesive agent, wherein the chip T of the arc tube may be dented not to project from the outer surface of the arc tube 11. After the bases 13 are attached thereto, markings M which show the position of the chip T are put on the both ends of the bases 13.

The water cooling jacket 20 is attached to a base plate or a frame of the apparatus through the jacket holders 23A and 23B and the leg members 201A and 201B, as described above. Therefore, the up-and-down direction of the water cooling jacket 20 is defined by the positions of the leg members 201A and 201B attached to the jacket holders 23A and 23B. That is, the up-and-down direction of the jacket holders 23A and 23B is defined by the positions of the leg members 201A and 201B.

Since the lamp holders 30A and 30B are fixed to the jacket holders 23A and 23B with screws 32A and 32B, the up-and-down direction of the lamp holders 30A and 30B is determined by the relation between the jacket holders 23A and 23B and screw holes for the screws 32A and 32B. On the other hand, the lamp 100 is fixed by inserting the bases 13 in lamp holders 30A and 30B and fastening the setscrews 31A and 31B therein. However, since, as described above, the up-and-down direction of the lamp holders 30A and 30B is defined by the relation with the jacket holders 23A and 23B, the lamp is rotated around a tube axis thereof so as to be fixed by the setscrews 31A and 31B so that the position of the chip T is located below the lamp holders 30A and 30B, while looking at the marking M formed in the bases 13. The lamp 100 can be arranged in the cooling jacket 20 so that the portion where the chip T of an arc tube 11 is formed may be located in a lower portion in the gravity direction.

The preceding description has been presented only to illustrate and describe exemplary embodiments of the present a light source for ultraviolet ray irradiation according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light source for ultraviolet ray irradiation, comprising:
a rod-shaped discharge lamp having an arc tube, wherein a chip formed in the arc tube is dented so as not to project from an outer surface of the arc tube,
a cooling jacket having an inner pipe and an outside pipe, between which cooling fluid flows,
wherein the discharge lamp is arranged so that a portion where the chip of the arc tube is formed is located in a lower portion in a gravity direction.

2. A light source for ultraviolet ray irradiation, comprising:
a rod-shaped discharge lamp having an arc tube, wherein a chip formed in the arc tube is dented so as not to project from an outer surface of the arc tube,
a cooling jacket having an inner pipe and an outside pipe, between which cooling fluid flows,
wherein the discharge lamp is arranged so that a position of a portion where the chip of the arc tube is fall within a range of ±45, where a vertical direction from a center of the discharge lamp is defined as zero degree.
